(19) United States
(12) Patent Application Publication
(10) Pub. No.: US 2004/0015731 A1
(43) Pub. Date: Jan. 22, 2004

(54) Intelligent data management fo hard disk drive

(75) Inventors: Frank R. Chu, Milpitas, CA (US); Steven R. Hetzler, Los Altos, CA (US)

Correspondence Address: JOSEPH P. CURTIN, 1469 N.W. MORGAN LANE, PORTLAND, OR, 97229, US

(73) Assignee: International Business Machines Corporation, Armonk, NY (US)

(21) Appl. No.: 10/195,478

(22) Filed: Jul. 16, 2002

(51) Int. Cl. G06F 1/26

(52) U.S. Cl. 713/300

(57) ABSTRACT

Power control logic in a disk drive controls a mode of operation of operational logic of the disk drive for reduced power consumption. The operational logic includes a first and a second mode of operation, such that the second mode of operation consumes less power than the first mode of operation. The power control logic includes a memory, and is coupled to communication signals over an interface. In response to a predetermined communication signal, the power control logic configures the memory for storing data that is related to the predetermined communication signal.

### BACKGROUND OF THE INVENTION

1. Field of the Invention

The present invention relates to the field of disk drives, other storage (e.g., optical) or other peripheral with a cache (e.g., network device), and other components for a computer-based system. More particularly, the present invention relates to a system and method for controlling power modes of a disk drive or of a peripheral component for a computer-based system.

2. Background of the Invention

Hard Disk Drives (HDDs) have multiple power modes that trade-off energy consumption for response time. Accordingly, a power mode having a relatively short response time has an associated relatively higher energy consumption because a greater proportion of the HDD is powered up and active. Typical power modes for an HDD include an Active, one or more Idle modes (i.e., Performance Idle, Active Idle, and Lower Power Idle), a Standby mode and a Sleep (or Low Power) mode. Other mobile computer peripheral devices, such as a microprocessor (μP) and a liquid crystal display (LCD), provide power modes that are analogous to HDD power modes.

Low-power modes for HDDs are characterized by reducing or halting electronic functions and slowing or halting mechanical motion. For example, in the Standby mode for an HDD, the disk is not spinning, and much of the electronics are powered down. The interface electronics, however, remain powered, typically consuming 250 mW. Because the interface activity is minimal during a low-power mode, much of the power used for the interface is wasted.

An HDD operating in the Sleep mode, which consumes the least amount of power of the different power modes, returns to the Active mode in response to a specific command received by the HDD. An HDD operating in either of the Idle and Standby modes returns to the Active mode in response to any command received by the HDD so that the use of the low-power Idle and Standby modes are transparent to the host system. Such capability requires that the interface remain responsive and that state information is retained by the HDD during the Idle and Standby modes. These capabilities are conventionally achieved by keeping the interface control electronics of the HDD fully operational during both the Idle and Standby modes.

For example, when an HDD is operating in the Standby mode, bus commands are constantly monitored and interpreted. This is done conventionally by keeping each of the hard disk controller (HDC), the microprocessor (μP), the random access memory (RAM) and the clocking (CLK) circuits of the HDD operational. The corresponding power consumption for the Standby mode is about 300 mW, and the recovery time from the Standby mode is about 1.5 seconds.

U.S. patent application Ser. No. 09/659,784, to F. Chu et al. discloses a system and method for controlling the power consumption in an HDD, so that in one low power mode, referred to as the enhanced Standby (eStby) mode, the power consumption of the HDD is substantially reduced in comparison to the Standby power mode, and so that there is minimal impact on HDD performance.

Nevertheless, what is needed is a way to reduce power consumption in a hard disk drive in situations in which a host device writes data to or read data from the drive. In particular, what is needed is a way to reduce power consumption in a mobile hard disk drive, such as is used in a digital camera or in a personal digital music player (i.e., MP3 player), without adversely impacting operating performance of the mobile hard disk drive.

### BRIEF SUMMARY OF THE INVENTION

The present invention provides a method and a system for reducing power consumption in a hard disk drive, other storage (e.g., optical) or other peripheral with a cache (e.g., network device), and other components in situations in which a host device writes or reads data from the drive. More particularly, the present invention provides a method and a system that reduces power consumption in a mobile hard disk drive, other storage (e.g., optical) or other peripheral with a cache (e.g., network device), and other components without adversely impacting operating performance of the device.

The advantages of the present invention are provided by a device, such as a disk drive, that includes operational logic and power control logic. The operational logic provides a first and a second mode of operation, and is responsive to communication signals over an interface connected to a host computer for performing input/output operations. According to the invention, the second mode of operation consumes less power than the first mode of operation. The power control logic includes a memory, and controls the operational logic when the operational logic is in the second mode of operation. The power control logic is also coupled to the communication signals over the interface and, in response to a predetermined communication signal, configures the memory for storing data that is related to the predetermined communication signal.

In the situation when the predetermined communication signal is a write data command, the power control logic configures the memory to include a write cache. Write data received subsequently to the predetermined communication signal is stored in the write cache. The power control logic controls the operational logic to transition to the first mode of operation and perform an output operation using the write data stored in the write cache when the memory is a predetermined percentage full containing the write data. According to another embodiment of the invention, the predetermined percentage is based on a rate that write data is being stored in the write cache.

In the situation when the predetermined communication signal is a read data command, the power control logic configures the memory to include a read cache. The operational logic is then controlled to transition to the first mode of operation and perform an input operation. Read data is received during the input operation, which can include a read-ahead read operation, and the power control logic stores the received read data in the read cache. When the power control logic receives a second read command, the power control logic performs an output operation when data corresponding to the second read command is stored in the read cache.

According to another embodiment of the invention, the memory includes a write cache and a read cache, and the power control logic configures the memory by enabling at least one counter associated with one of the write cache and the read cache.

### BRIEF DESCRIPTION OF THE DRAWINGS

The present invention is illustrated by way of example and not by limitation in the accompanying figures in which like reference numerals indicate similar elements and in which:

FIG. 1 is a block diagram that illustrates an exemplary general configuration of the system according to the present invention;

FIG. 2 is a detailed block diagram of an exemplary power management system according to the present invention;

FIG. 3 is a block diagram of an exemplary disk drive having a power-control system providing an eData power mode according to the present invention;

FIG. 4 is a block diagram indicating exemplary functions performed by a State Machine that controls the eData power mode according to the present invention; and

FIG. 5 is an exemplary flow diagram for illustrating an overview of the eData mode according to the present invention;

### DETAILED DESCRIPTION OF THE INVENTION

The present invention provides an intelligent data management power mode, referred to herein as the eData power mode or the eData mode, that can be utilized in all types of HDDs, other storage (e.g., optical) or other peripheral with a cache (e.g., network device), and other components in situations in which a host device writes or reads data from the device. A mobile HDD, such as used in, for example, a digital camera or an MP3 player, performs data access operations that are mostly sequential data access operations. The eData power mode of the present invention is optimally suited for sequential data access patterns.

The power consumption level of the eData power mode is between the power consumption level of a conventional Idle mode and the eStby mode, as disclosed in U.S. patent application Ser. No. 09/659,784, to F. Chu et al. For example, the present invention reduces the energy required to store a picture in some digital cameras by a factor of 10. Moreover, the eData power mode of the present invention causes no adverse impact on the performance of an HDD when the HDD operates in the eData power mode.

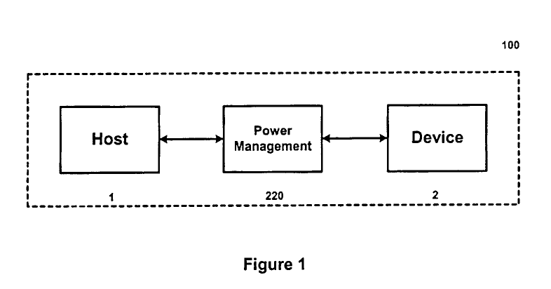

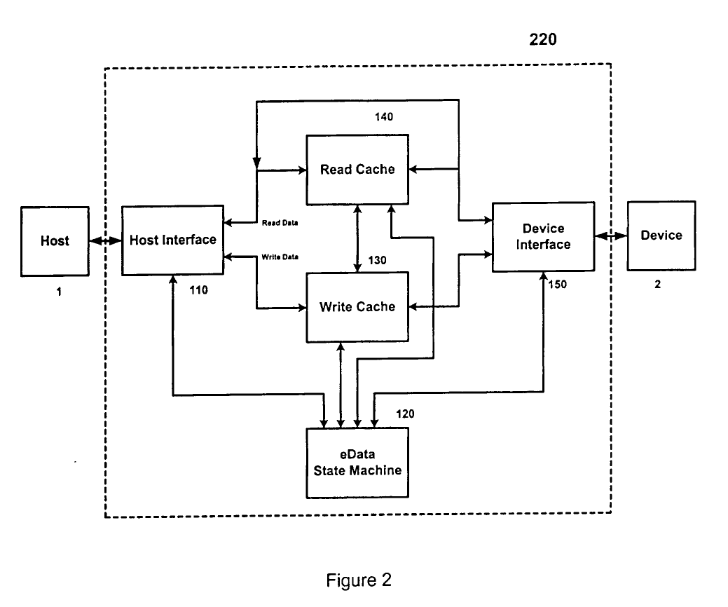

FIG. 1 shows a block diagram of an exemplary system utilizing the present invention, indicated generally as 100. Power Management Unit 220 is interposed between host 1 and device 2. FIG. 2 illustrates the details of an exemplary power management unit 220. Power management unit consists of Host Interface 110, eData State Machine 120, Write Cache 130, Read Cache 140, and Device Interface 150. In some applications, the system may include only one of Write Cache 130 and Read Cache 140.

According to the present invention, the overall system power consumption is reduced while maintaining the overall system performance. Power Management Unit 220 will utilize Read Cache 140 and Write Cache 130 to process commands from Host 1 in order to minimize the system power consumption. Device 2 will not need to be active for each command from Host 1. All read and write operations between Host 1 and Device 2 will go through Power Management Unit 220. eData State Machine 120 contains logic for managing Read Cache 140, Write Cache 130, Host Interface 110, and Device Interface 150, to provide the most optimal power consumption and maintain the overall system performance.

For example, if Host 1 requests the status of Device 2, then eData State Machine 120 will perform the status return, without forwarding the status command to Device 2. Thus, the power state of Device 2 is unaffected, allowing it to remain in a low power state.

When Host 1 issues a data write command, eData State Machine 120 will determine if Write Cache 130 can accept the write data. If Write Cache 130 can accept the data, then the data is written into Write Cache 130 and the power state of Device 2 is unaffected. Write Cache 130 may be unable to accept the data under certain conditions, such as insufficient free space in the cache, or the write data exceeds the capabilities of the cache management. An example of the latter case can occur when Write Cache 130 has the ability to hold a fixed number of sequential write data sets, and the new write command exceeds this limit.

eData State Machine 120 is responsible for monitoring the ability of Write Cache 130 to accept more data. If Write Cache 130 is at or near its limits, then eData State Machine 120 issues commands over Device Interface 150 to write the data to Device 2 (flush operation). The timing of this operation is determined by eData State Machine 120. To minimize energy, it may be beneficial to delay the flush operation until a subsequent host command that requires accessing Device 2. A further condition would be based on the maximum time data should remain in Write Cache 130.

When Host 1 issues a data read command, and all of the requested data is stored in Read Cache 140 or Write Cache 130, then the State Machine 120 returns the requested data to Host 1 without affecting the power state of Device 2. If any of the requested data is not stored in Read Cache 140 or Write Cache 130, then eData State Machine 120 will issue the necessary read commands over Device Interface 150 to read the appropriate data from Device 2 and send it to Host 1. Once Device 2 has satisfied the read requests, eData State Machine 120 is able to perform additional read operations to fill up Read Cache 140, or to flush Write Cache 130. One of the most common techniques is the read ahead operation, in which more data is read from Device 2 following the last data request by Host 1.

FIG. 2 is a detailed block diagram of an exemplary power management system according to the present invention. Operationally, the invention acts on data and commands passing between Host 1 and Device 2. In general, it is possible to integrate all or part of the invention into either device.

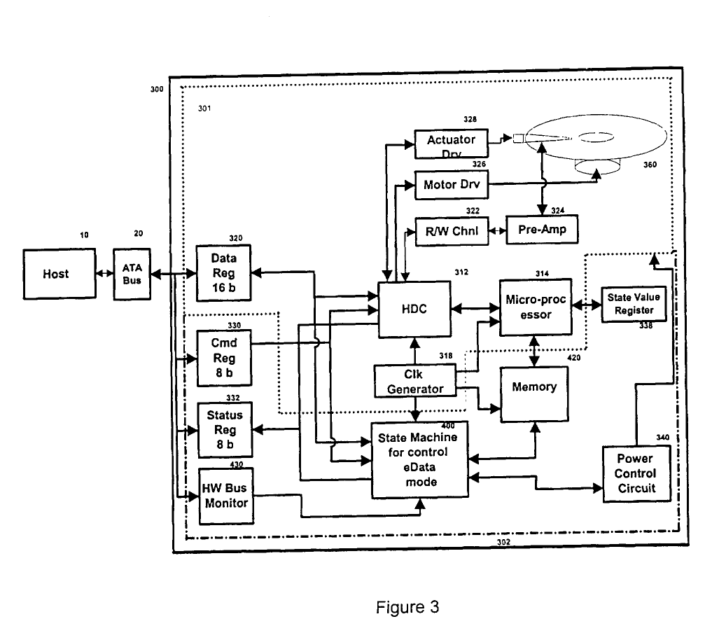

FIG. 3 shows a schematic block diagram of an exemplary hard disk drive (HDD) 300 having an eData power mode according to the present invention. HDD 300 includes electronic circuitry 301 and eData power mode control circuitry 302. Electronic circuitry 301 includes the dynamic-type circuitry of HDD 300, such as a Hard Disk Controller (HDC) 312, a microprocessor 314, a clock generator circuit 318, a 16-bit Data register 320, a Read/Write (R/W) channel (CHNL) circuit 322, a pre-amplifier 324, a motor drive 326, an actuator drive 328 and Media 360. HDD 300 is connected to a Host computer 10 through an ATA bus 20. While bus 20 is shown in FIG. 3 as an ATA bus circuit, it should be understood that an SCSI bus circuit, a Serial ATA bus circuit, a Serial Attached SCSI bus circuit, a Fibre Channel bus circuit, a USB bus circuit, a Firewire bus circuit, a Gigabit Ethernet bus circuit, and an InfiBand bus circuit are all suitable bus circuits for the present invention.

Electronic circuitry 301 operates in a well-known manner to provide features and functions associated with conventional HDDs. Commands, status information and data are communicated between Host computer 10 and HDD 300 over ATA bus 20 in a well-known manner. Additionally, power control circuitry 340 operates in a well-known manner to supply power to specific portions of HDD 300 in a well-known manner, thereby providing various power modes of operation. Circuitry for controlling power control circuitry 340 to provide the various conventional power modes and for transitioning HDD 300 between the various conventional power modes is not shown in FIG. 3. eData Power mode-control circuitry 302 includes static-type circuitry, such as an 8-bit Command register 330, an 8-bit Status register 332, a State Machine 400, a State Value register 338, a Memory 420, a Hardware Bus Monitor circuit 430, and Power Control Circuit 340. Each of Command register 330, Status register 332 and Hardware Bus Monitor circuit 430 is connected to ATA bus 20. State Machine 400 provides power control logic commands to Power Control Circuit 340 for controlling the eData power mode. State Machine 400 can be embodied as a dedicated electronic logic circuit, such as an Application Specific Integrated Circuit (ASIC) or as a processor device that execute software.

When HDD 300 is in the eData mode, all mechanical components are turned off, as are almost all electrical components, such as HDC 312, Microprocessor 314, R/W Channel 322, Pre-Amp 324, Motor Driver 326, and Actuator Driver 328. When HDD 300 is in the eData power mode, State Machine 400 controls a data transfer between Host 10 and HDD 300 by (electronically) storing the data in RAM Memory 420. Hence, the power mode provided under the control of State Machine 400 is referred to herein as the e(lectronic)Data power mode.

According to one exemplary embodiment of the invention, when HDD 300 is operating in the eData mode and receives a write data command, State Machine 400 configures Memory 420 to include a write data buffer and various counters, such as a Logical Block Address (LBA) counter, a data size counter, a cache buffer available size counter, and a host data access frequency counter, that are used for determining the optimum time for transitioning HDD 300 to the Active mode for performing a write data operation. Simultaneously, when HDD 300 is operating in the eData mode and receives a read data command, State Machine 200 configures Memory 420 to include a read data buffer and various counters, such as an LBA counter, a data size counter, a read cache hit counter, and a host data access frequency counter, that are used for determining the optimum time for transitioning HDD 300 to the Active mode for performing a read data operation. Subsequent to either of these two operations, State Machine 400 can use the frequency of host data accesses to determine the most energy-efficient power mode, such as any of the various Idle modes, the Standby mode, the eStby mode, or to the eData mode, for transitioning HDD 300 to after a write or a read operation. For example, U.S. Pat. No. 5,682,273 teaches a method for using access frequency to determine transitions between power modes, such an in a mobile HDD. According to another exemplary embodiment of the invention, Memory 420 is simultaneously configured for responding to either a write data command or a read data command by containing both a write data cache and a read data cache, and the various counters that are used in connection with each cache.

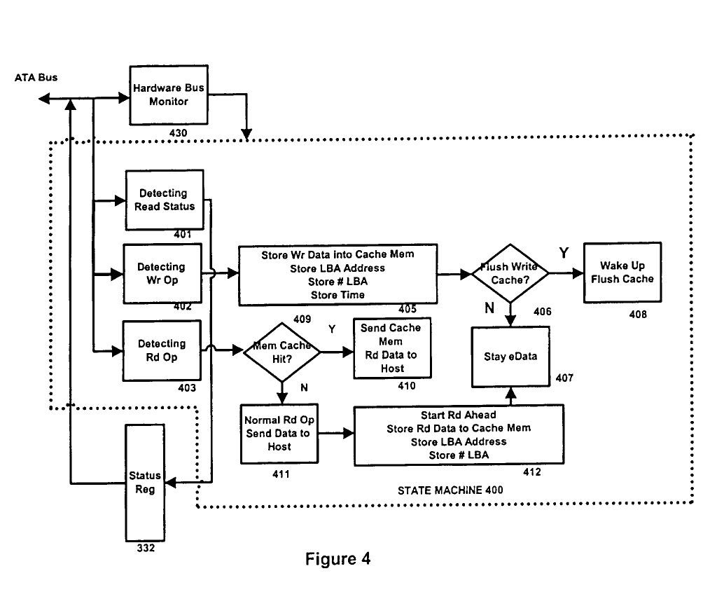

FIG. 4 shows a block diagram indicating exemplary functions that are performed by State Machine 400 for controlling the eData power mode. Hardware Bus Monitor Circuit 430 detects bus activity on ATA bus 20 that is directed to HDD 300 and generates a corresponding output that is used by State Machine 400 and other power mode control circuits. When HDD 300 is in the eData mode, State Machine 400 responds to Hardware Bus Monitor Circuit 430 by determining whether the bus activity is a read status command (function 401), a write data operation command (function 402) or a read data operation command (function 403).

When a read status command is detected (function 401), the contents of Status Register 332 are returned to Host 10. When a write data operation is detected (function 402), State Machine 400 stores the write data in a write cache memory located in Memory 420 (function 405). Additionally, State Machine 400 stores the logical block address (LBA), the number of LBAs, and a representation of time of the command, for the write data in the write cache. State Machine 400 then determines whether a write flush of the write cache should be performed (function 406), that is, whether the contents of the write cache should be written to media 360 of HDD 300 (FIG. 3). When a write flush should not be performed, State Machine 400 causes HDD 300 to remain in the eData mode (function 407). When a write flush should be performed, State Machine 400 causes HDD 300 to transition the Active mode and the contents of the write cache are written to the disk media (function 408). For cases where the write data block size is much larger than the available write cache memory, then the State Machine 400 needs to wake up HDD 300 to flush the write cache before proceeding with a normal write data operation to the Media 360.

When a read data operation 403 is detected, State Machine 400 determines whether the read data command results in a cache hit within a read cache located in Memory 420 (function 409). When the read data command results in a hit, the corresponding contents of the read cache are returned to Host 10 (function 410). When the read command does not result in a cache hit, State Machine 400 causes HDD 400 to enter the Active mode, perform a normal read data operation and return the requested data to Host 10 (function 411). State Machine 400 then enables read-ahead capability, reads additional sequential data, stores the additional sequential data in the read cache (function 412). State Machine 400 then causes HDD 400 to remain in the eData mode (function 407).

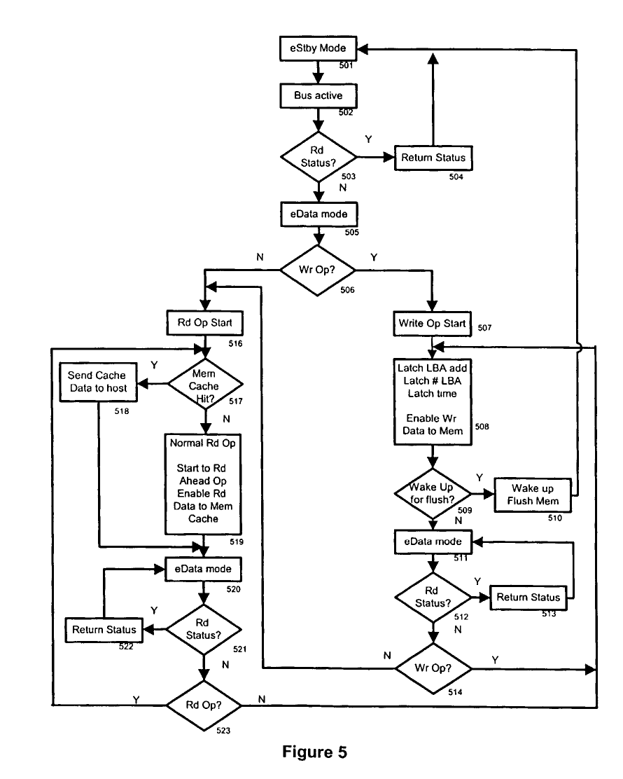

FIG. 5 is an exemplary flow diagram 500 for illustrating an overview of the eData mode according to the present invention. When HDD 300 is initially turned on, HDD 300 performs conventional initialization routines and procedures that are not shown in FIG. 5. At some point while HDD 300 is operating, and when no further host-required disk activity occurs, HDD 300 transitions to the eStby mode at step 501, so that the disk is no longer spinning and the heads are unloaded. When the bus is active at step 502, flow continues to step 503 where it is determined whether Host 10 has issued a Read Status command. If so, flow continues to step 504 where the status is returned and the process returns to step 501. If, at step 503, the bus activity is not a Read Status command, but is a command for a write operation or a read operation, flow continues to step 505 where HDD 300 transitions from the eStby mode into the eData mode.

Flow continues to step 506 where it is determined whether the received command is for a write operation or for a read operation. If the command is a write operation, flow continues to step 507 where a write cache and various counters are configured and enabled within Memory 420, i.e., the LBA counter, the data size counter, the cache buffer available size counter, and the host data access frequency counter. The LBA counter is used to store the starting address of the data. The data size counter is used to store the number of LBAs. The Cache buffer available size counter holds available capacity of the cache buffer after each cache write operation. The Host data access frequency counter is used to determine how often is host performs write operation.

Flow continues to step 508 where State Machine 400 begins to manage the interactions with ATA bus 20 by receiving the incoming host data, latching the LBA and time, and storing the host data in the write cache buffer that as been configured within Memory 420.

Flow continues to step 509, where, according to a first embodiment of the present invention, State Machine 400 determines whether a flush write cache should occur based on the write cache being a predetermined percentage full, such as 75% full. When the predetermined percentage full threshold condition has been met, flow continues to step 510 where HDD 300 is transitioned to the Active mode while the write cache continues to fill. The cache is flushed as soon as HDD 300 is ready to write. The process transitions HDD 300 to the eStby mode at step 501 when no further host-required disk activity occurs, unless an eData mode exit condition is encountered, such as when an out-of-sequence write or read command is received.

According to another embodiment of the present invention, State Machine 400 determines whether a flush write cache should occur based on an adaptive fill target relating to a percentage of fullness of the write cache. For example, a percentage-full threshold is adjusted based on the incoming data rate so that that the write cache flush operation is the most energy efficient, such as shortly before the write cache is full.

In yet another alternative embodiment of the present invention, State Machine 400 determines whether a flush write cache should occur based on an the frequency system of access, and the mode transition energies and times. {For example, U.S. Pat. No. 5,682,273 teaches a method for using access frequency to determine transitions between power modes, such an in a mobile HDD.} This embodiment of the present invention also manages the state at the end of the cache flush as well, with HDD 300 typically being transitioned to the eData mode, unless an eData mode exit condition is encountered, such as when an out-of-sequence write or read command is received.

If, at step 509, State Machine 400 determines that a flush write cache should not occur, flow continues to step 511 where HDD 300 remains in the eData mode until bus activity is detected, then flow continues to step 512. At step 512, State Machine 400 determines whether any detected bus activity is a Read Status command. If so, flow continues to step 510 where the status is returned to Host 10. Subsequently, flow returns to step 511. If, at step 512, the detected bus activity is not a read status, flow continues to step 514 where State Machine 400 determines whether the detected bus activity is a write operation command. If so, flow returns to step 508. If, at step 514, the bus activity is a read operation command, flow continues to step 516. If, back at step 506, the received command is a read operation, flow continues to step 516 where the read cache and various counters are configured within Memory 420, such as the LBA counter, the data size counter, the read cache hit counter, and the host data access frequency counter, and are enabled. Flow continues to step 517 where State Machine 400 determines whether the read command results in a memory cache hit. If so, flow continues to step 518 where the “hit” cache data is sent to Host 10. Flow continues to step 520. If, at step 517, the read command does not result in a cache hit, flow continues to step 519 where State Machine 400 determines to wake up the rest of HDD 300, to return to Host 10 the requested read data, then it will read additional data from media 360 and for storing these additional read data in the read cache. Flow continues to step 520. According to another exemplary embodiment of the present invention, State Machine 400 could determine that Host 10 is accessing data from the media in a random manner so that the eData mode may not be a suitable mode, and the eData mode is exited.

At step 520, the eData mode is re-entered, and when bus activity is detected, flow continues to step 521. If, at step 521, the bus activity is a read status command, flow continues to step 522 where the status is returned to Host 10. Flow returns to step 520. If, at step 521, the bus activity is not a read status command, flow continues to step 523 where it is determined whether the bus activity is a read command or a write command. When, at step 523, the bus activity is a read command, flow returns to step 517. When the bus activity is a write command, flow continues to step 508.

While at eData mode, if no further host activity is detected, then the State Machine 400 will exit eData mode by first to flush the write cache and then return to a lower power eStby mode.

Table 1 shows exemplary energy consumption data for an eData-enabled IBM Microdrive for use in a Kodak DC260 digital cameral:

TABLE 1

| | | | Microdrive having |
|---|---|---|---|
| | Flash | Microdrive | eData |
| One hi-res photo, 350 kB | 1.25 J | 21.45 J | 2.04 J |
| Two hi-res photos | 2.50 J | 42.90 J | 3.09 J |

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A device, comprising:
operational logic responsive to communication signals over an interface for performing input/output operations, the operational logic providing a first and a second mode of operation, the second mode of operation consuming less power than the first mode of operation; and
power control logic including a memory, the power control logic controlling the operational logic when the operational logic is in the second mode of operation, the power control logic being coupled to the communication signals over the interface and configuring the memory for storing data when a predetermined communication signal is received by the power control logic, the data being related to the predetermined signal.

2. The device according to claim 1, wherein the device is a disk drive.

3. The device according to claim 2, wherein the disk drive is connected to a host computer over the interface.

4. The device according to claim 2, wherein the disk drive is part of an electronic camera.

5. The device according to claim 2, wherein the disk drive is part of a personal digital music player.

6. The device according to claim 1, wherein the device is an optical drive.

7. The device according to claim 6, wherein the optical drive is connected to a host computer over the interface

8. The device according to claim 6, wherein the optical drive is part of an electronic camera.

9. The device according to claim 6, wherein the optical drive is part of a personal digital music player.

10. The device according to claim 6, wherein the device is one of a CD-ROM, a CD-RW, a CD-R, a DVD-ROM, a DVD-RW and a DVD-R.

11. The device according to claim 1, wherein the device is a network-attached storage device.

12. The device according to claim 11, wherein the network-attached storage device is connected to a host computer over the interface.

13. The device according to claim 1, wherein at least one of the operational logic and the power control logic is an electronic circuit.

14. The device according to claim 1, wherein the predetermined communication signal is a write data command, and
wherein the power control logic configures the memory to include a write cache, receives subsequently to the predetermined communication signal and stores the received write data in the write cache.

15. The device according to claim 14, wherein the power control logic controls the operational logic to transition to the first mode of operation and perform an output operation using the write data stored in the write cache when the memory is a predetermined percentage full containing the write data.

16. The device according to claim 15, wherein the predetermined percentage is based on a rate that write data is being stored in the write cache.

17. The device according to claim 1, wherein the predetermined communication signal is a read data command,
wherein the power control logic configures the memory to include a read cache and controls the operational logic in response to the predetermined communication signal to transition to the first mode of operation and perform an input operation, and
wherein the operational logic receives read data during the input operation and the power control logic stores the received read data in the read cache.

18. The device according to claim 17, wherein the read data is received during a read-ahead read operation.

19. The device according to claim 17, wherein the power control logic receives a second read command and performs an output operation when data corresponding to the second read command is stored in the read cache.

20. The device according to claim 1, wherein the memory includes a write cache and a read cache, and
wherein when the power control logic configures the memory for storing data, and enables at least one counter associated with one of the write cache and the read cache.

21. The device according to claim 1, wherein the power control logic is coupled to a bus circuit connected between the operational logic and a host computer.

22. The device according to claim 21, wherein the bus circuit is one of an ATA bus circuit, an SCSI bus circuit, a Serial ATA bus circuit, a Serial Attached SCSI bus circuit, a Fibre Channel bus circuit, a USB bus circuit, a Firewire bus circuit, a Gigabit Ethernet bus circuit, and an InfiBand bus circuit.

23. A method for controlling power of a device, the device having operational logic, the method comprising steps of:
detecting a communication signal over an interface intended for the operational logic of the device, the operational logic having a first mode of operation and a second mode of operation, the operational logic consuming more power in the first mode of operation than in the second mode of operation, the communication signal being detected when the operational logic is in the second mode of operation; and
configuring a memory for storing data when a predetermined communication signal is received by the power control logic, the data being related to the predetermined signal.

24. The method according to claim 23, wherein the device is a disk drive, an optical drive, or a network-attached storage device.

25. The method according to claim 24, wherein the device is connected to a host computer over the interface.

26. The method according to claim 24, wherein the device is part of an electronic camera.

27. The method according to claim 24, wherein the device is part of a personal digital music player.

28. The method according to claim 23, wherein the predetermined communication signal is a write data command, and
wherein the memory is configured to include a write cache,
the method further comprising steps of:
receiving write data received subsequent to the predetermined communication signal; and
storing the received write data in the write cache.

29. The method according to claim 28, further comprising steps of:
transitioning the operational logic to the first mode of operation; and
perform an output operation using the write data stored in the write cache when the memory is a predetermined percentage full containing the write data.

30. The method according to claim 29, wherein the predetermined percentage is based on a rate that write data is being stored in the write cache.

31. The method according to claim 23, wherein the predetermined communication signal is a read data command,
wherein the memory is configured to include a read cache,
the method further comprising steps of:
transitioning the operational logic to the first mode of operation in response to the predetermined communication signal;
performing an input operation receiving read data; and
storing the received read data in the read cache.

32. The method according to claim 31, further comprising a step of receiving the read data during a read-ahead read operation.

33. The method according to claim 31, further comprising steps of:
receiving a second read command; and
performing an output operation when data corresponding to the second read command is stored in the read cache.

34. The method according to claim 23, wherein the memory includes a write cache and a read cache, and
wherein the step of configuring the memory for storing data enables at least one counter associated with one of the write cache and the read cache.
